(19) United States
(12) Patent Application Publication
(10) Pub. No.: US 2007/0109136 A1
(43) Pub. Date: May 17, 2007

(54) Portable alarm device

(76) Inventors: Kenichi Hirooka, Osaka (JP); Masashi Yoshimura, Osaka (JP)

Correspondence Address: RABIN & Berdo, PC, 1101 14TH STREET, NW, SUITE 500, WASHINGTON, DC, 20005, US

(21) Appl. No.: 11/416,071

(22) Filed: May 3, 2006

(30) Foreign Application Priority Data
Nov. 15, 2005 (JP) 2005-330575

(51) Int. Cl. G08B 13/00

(52) U.S. Cl. 340/574

(57) ABSTRACT

A portable alarm device comprises a main body, an operation member and an actuating member. The main body contains an alarm sound emitting unit and a switch for operating the alarm sound emitting unit. The operation member is detached from the main body in an axial direction of the main body, and thereby the switch is closed. A locking member is provided in the main body and is displaceable between a locking position for preventing the detachment of the operation member and an unlocking position for allowing the detachment of the operation member. The actuating member drives the locking member to the unlocking position in accompany with either an action of grasping the main body in a radial direction by hand or an action of relative movement of the operation member and the main body grasped by hand in the axial direction of the main body.

### CROSS REFERENCE TO RELATED APPLICATION

This application corresponds to the Japanese Patent Application No. 2005-330575 filed with the Japan Patent Office on Nov. 15, 2005, and the whole disclosure of the application is incorporated in this application by citation.

### BACKGROUND OF THE INVENTION

1. Field of the Invention

This invention relates to a portable alarm device.

2. Description of Related Arts

Recently, various kinds of articles of criminal prevention have been proposed for informing a third person of a criminal offense of a robber, ruffian or the like when a user meets with the criminal offence.

For example, alarm devices have been proposed in which a strap of a cell phone and a criminal preventing buzzer are integrated and the criminal preventing buzzer sounds by pulling out the strap. In such a kind of alarm device, usually an improper operation preventing button is provided and the strap cannot be pulled out without simultaneously pressing the improper operation preventing button (see, for example, Japanese Utility Model Registration Publication No. 3086405 and Japanese Unexamined Patent Publication No. 1997-293186).

However, it is difficult for a user in a fright to seek the position of the improper operation preventing button and press the same well. Therefore, it is supposed that the strap cannot be pulled out and the criminal preventing buzzer cannot be operated.

An object of the present invention is to provide a portable alarm device capable of being surely operated in an emergency.

### SUMMARY OF THE INVENTION

In order to achieve the abovementioned object, a portable alarm device according to an embodiment of the present invention comprises a cylindrical main body containing therein an alarm sound emitting unit and a switch for operating the alarm sound emitting unit, and an operation member which closes the switch by being detached from the main body in an axial direction of the main body. This portable alarm device further comprises a locking member provided in the main body and displaceable between a locking position for preventing the detachment of the operation member and a unlocking position for allowing the detachment of the operation member, and an actuating member for driving a locking member to the unlocking position in accompany with either one of an action of grasping the main body in a radial direction by hand and an action of relative movement of the operation member and the main body grasped by hand in the axial direction of the main body.

In this embodiment of the present invention, the actuating member is displaced during the basic action of detaching the operation member and the main body from each other in the axial direction with grasping the main body, and as a result, the lock of the operation member and the main body can be easily released. In comparison with a case in which a user has to separately seek an unlocking button or the like and press the button, the necessary action in this embodiment is remarkably rapid and in addition, has a higher sureness. The main body detached from the operation member can be thrown far away without need of passing to the other hand and the like actions.

The operation member preferably includes a pin directly or indirectly attached with a string, belt or chain to be passed around a belonging or a neck. Thereby, since the pin is held by the portable member or the like, the pin and the main body can be easily detached from each other by pulling the main body.

### BRIEF DESCRIPTION OF THE DRAWINGS

FIG. 1 is a sectional view of a portable alarm device according to an embodiment of the present invention.

FIG. 2 is a sectional view of the portable alarm device seen from another angle.

FIG. 3 is a schematical perspective view of a pair of locking plates and a pin.

FIG. 4 is a block diagram showing an electric structure of the portable alarm device.

FIG. 5 is a sectional view of the pin.

FIG. 6 is a perspective view showing a way of treating the portable alarm device.

FIGS. 7A and 7B are process views showing unlocking operation with respect to the pin.

FIGS. 8A and 8B respectively are a plan view and a side view of a portable alarm device according to another embodiment of the present invention.

FIGS. 9A and 9B respectively are a cross sectional view and a longitudinal sectional view of the portable alarm device of FIG. 8.

FIGS. 10A and 10B respectively are a plan view and a side view of a portable alarm device according to a further another embodiment of the present invention.

FIGS. 11A and 11B respectively are a cross sectional view and a longitudinal sectional view of the portable alarm device of FIG. 10.

FIGS. 12A and 12B respectively are a plan view and a side view of a portable alarm device according to a further another embodiment of the present invention.

FIGS. 13A and 13B respectively are a cross sectional view and a longitudinal sectional view of the portable alarm device of FIG. 12, and FIG. 13C is a schematical sectional view of a main part of the portable alarm device.

FIG. 14 is a side view of a portable alarm device according to a further another embodiment of the present invention.

FIGS. 15A and 15B respectively are a cross sectional view and a longitudinal sectional view of the portable alarm device of FIG. 14, and FIG. 15C is a schematical sectional view of a main part of the portable alarm device.

FIGS. 16A and 16B respectively are a plan view and a side view of a portable alarm device according to a further another embodiment of the present invention.

FIGS. 17A and 17B respectively are a cross sectional view and a longitudinal sectional view of the portable alarm device of FIG. 16.

FIG. 18 is a side view of a portable alarm device according to a further another embodiment of the present invention.

FIG. 19 is a sectional view of a main part of the portable alarm device of FIG. 18.

FIG. 20 is a pattern side view of a portable alarm device according to a further another embodiment of the present invention.

### DETAILED DESCRIPTION OF THE PREFERRED EMBODIMENTS

Now, preferred embodiments of the present invention will be described with reference to the appended drawings.

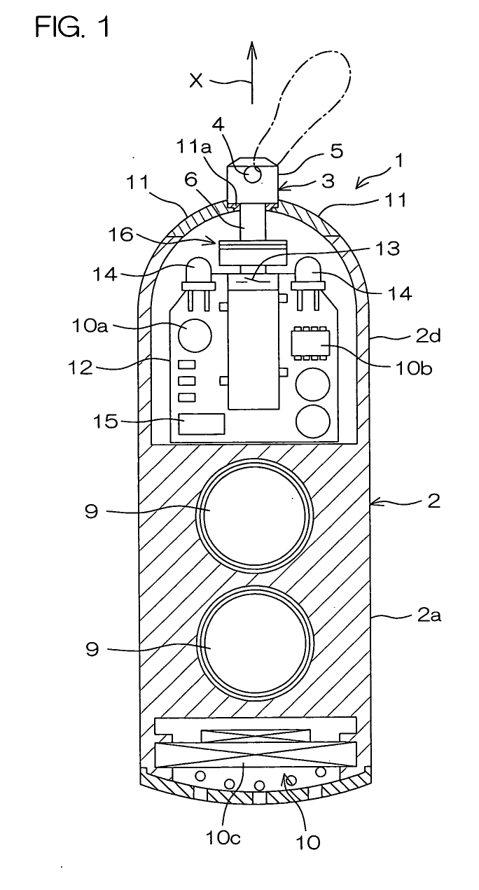

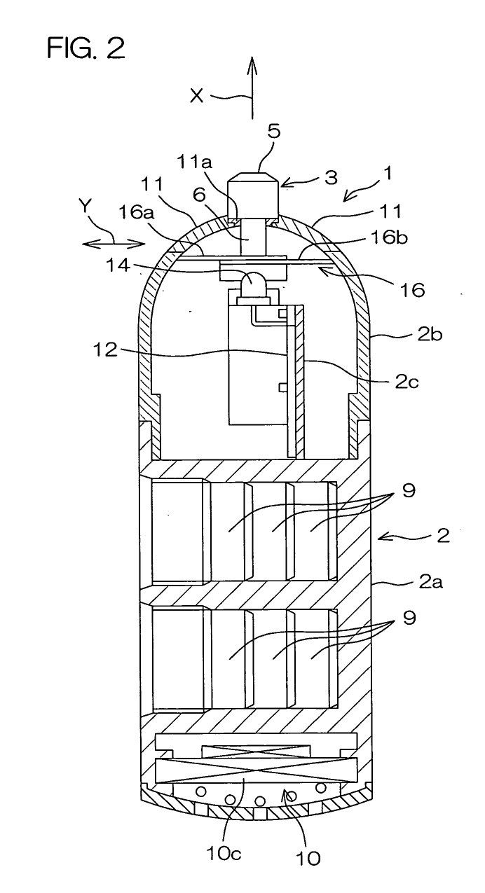

FIG. 1 is a schematical sectional view of a portable alarm device according to an embodiment of the present invention, and FIG. 2 is a sectional view of the portable alarm device seen from another angle. Referring to FIGS. 1 and 2, the portable alarm device 1 comprises a main body 2 and a pin 3 as an operation member detachable from the main body 2.

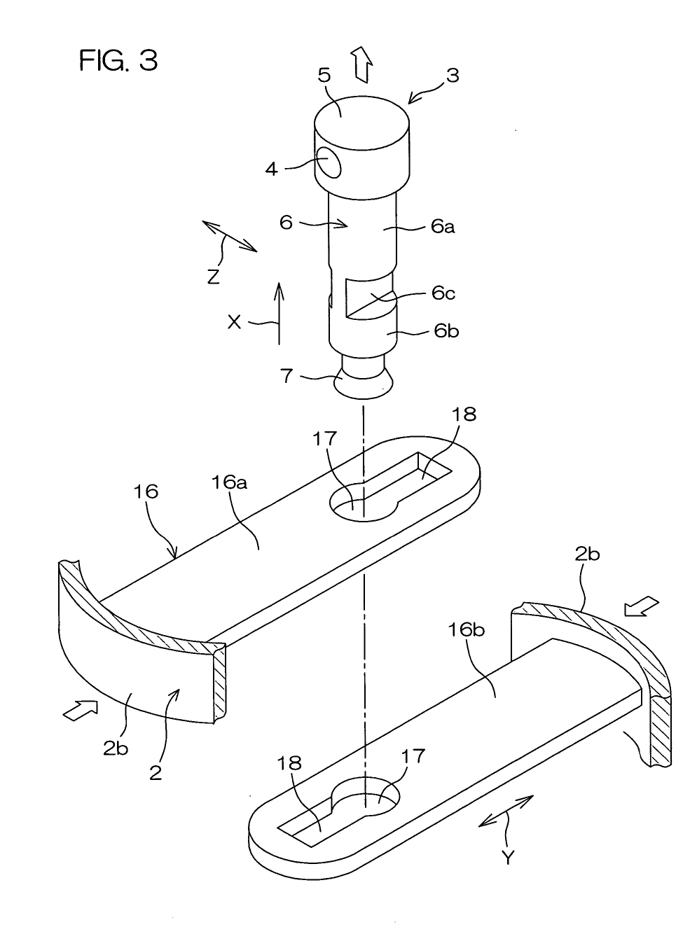

As shown in FIG. 3, the pin 3 includes a top portion 5 having a string stabbing hole 4, a shaft body 6 and a switch press-down portion 7 provided at an end of the shaft body 6. A string 8 passed around a belonging or a neck is passed through the string stabbing hole 4. The shaft body 6 includes a first wide portion 6a formed in continuation with the top portion 5, a second wide portion 6b formed in continuation with the switch press-down portion 7 and a narrow portion 6c provided between the first wide portion 6a and the second wide portion 6b.

Referring to FIG. 2, the main body 2 comprises a box-shaped body having a first portion 2a constituting mainly a lower portion and a second portion 2b as an actuating member (radially displacing member) constituting mainly an upper portion. As shown in FIGS. 1 and 2, the first portion 2a has an extended portion 2d upwardly extended in a circumferential portion. The second portion 2b allows the extended portion 2d of the first portion 2a to intrude into the circumferential portion thereof. The second portion 2b is provided not throughout the whole circumference but on the almost whole region in the direction of the circumference. In the first portion 2a of the main body 2, a battery 9 is provided. As the battery 9, for example, a plurality of button type butteries in each of which a plurality of rows is used. Further, at the lowest portion of the first portion 2a, a speaker 10c of a below mentioned alarm sound emitting unit 10 is held. At the bottom of the main body 2, minute through holes are provided for delivering sounds from the speaker 10c to the outside.

The second portion 2b as the actuating member is made of a resiliently deformable material such as ABS resin or other synthetic resins. And this second portion 2b as the actuating member functions also as a biasing member for returning both of the below mentioned locking plates as locking members to locking positions. However, a biasing member may be provided separately from the second portion 2b.

At the top end portion of the second portion 2b of the main body 2, a lens 11 is provided for passing the light from a light source 14. Provided at the central portion of the lens 11 is a shaft body penetrating hole 11a for inserting the shaft body 6 of the pin 3 therethrough. A sealing agent in such an amount as not hindering the pin 3 from being detached may be filled between an inner circumferential surface of the shaft penetrating hole 11a and the pin 3.

In the second portion 2b of the main body 2, a circuit substrate 12 is contained. The circuit substrate 12 is held by a support wall 2c as a third portion of the main body 2 formed integrally with the second portion 2b of the main body 2. Packaged on the circuit substrate 12 are the alarm sound emitting unit 10, a switch 13 for actuating the alarm sound emitting unit 10, the light source 14 such as a high brightness LED, a time measuring section 15 as a time measuring unit for measuring the time instant and the like.

Referring to FIG. 1, the alarm sound emitting unit 10 comprises an audio signal emitting section 10a for emitting audio signals, an amplifier 10b for amplifying a signal emitted from the audio signal emitting section 10a, and the speaker 10c for converting the audio signal amplified by the amplifier 10b into a sound. A loud sound and voice such as “Help!” of a female voice is outputted from the speaker 10.

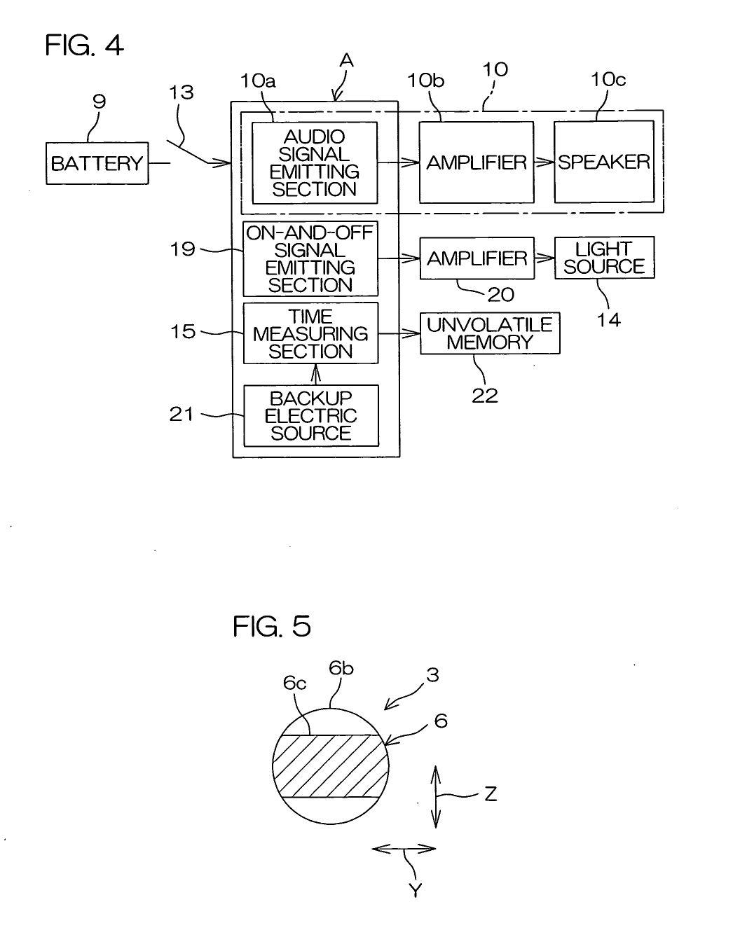

Referring to a block diagram of FIG. 4, a control section A constituted by a CPU, RAM, ROM and the like includes the abovementioned audio signal emitting section 10a, an blinking signal emitting section 19, the abovementioned time measuring section 15 and the like. The blinking signal emitting section 19 is connected through an amplifier 20 to the light source 14. Further, A backup electric source 21 provided in the control section A is connected to the time measuring section 15 so that the time measuring section 15 can be driven without any power supply from the battery 9. Further, an unvolatile memory 22 is connected to the time measuring section 15, and a time measurement data (time instant) outputted from the time measuring section 15 on closing the switch 13 can be stored in the unvolatile memory 22.

As shown in FIG. 1, contained in the second portion 2b of the main body 2 is a lock member 16 for preventing the pin 3 from being detached so as to prevent improper operation of the switch 13. As shown in FIGS. 2 and 3, the lock member 16 comprises a pair of locking plates 16a, 16b one end of each of which is connected to the inside surface of the second portion 2b as the resiliently deformable actuating member.

The pair of locking plates 16a, 16b are relatively displaceable in a direction of a relative movement (corresponding to a radial direction Y of the main body 2) perpendicular to a detachment direction X of the pin 3 in accompany with resilient deformation of the second portion 2b of the main body 2. As shown in FIG. 3, each of the locking-plates 16a, 16b includes a pin detachment hole 17 and through which the second wide portion 6b of the pin 3 can penetrate, and a pin detachment preventing channel 18 extended from the pin detachment hole 17 through which the second wide portion 6b of the pin 3 cannot penetrate but the narrow portion 6c of the pin 3 can penetrate. Referring to FIGS. 3 and 5, widths of the wide portions 6a, 6b and the narrow portion 6c of the pin 3 mean their widths in a direction Z perpendicular to the detachment direction X of the pin 3 and the direction of the relative movement (radial direction Y) of the locking plates 16a, 16b.

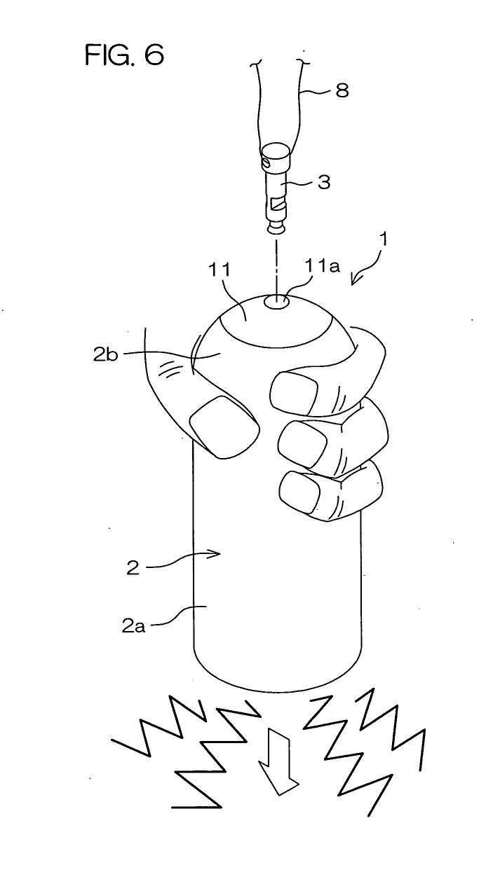

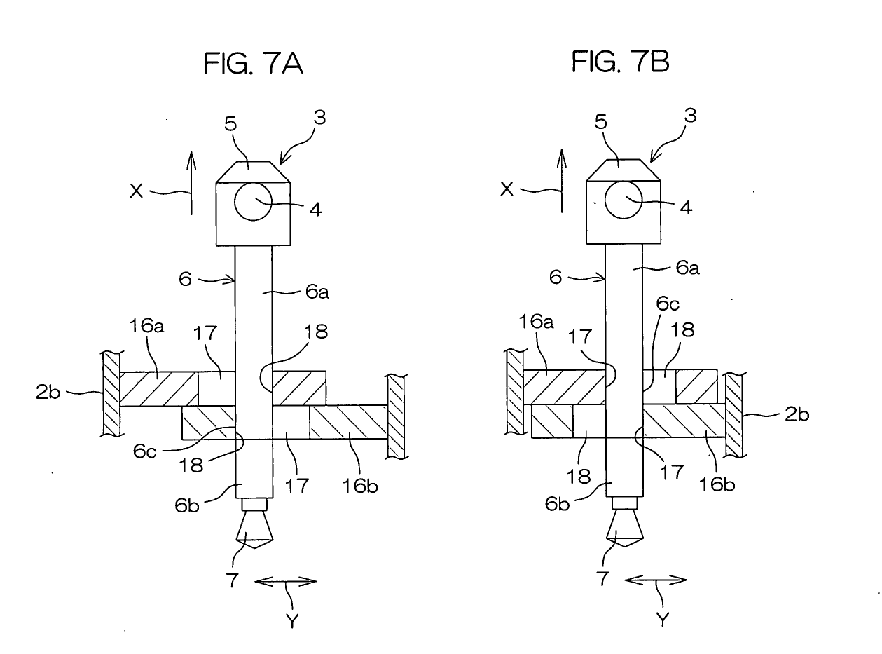

A feature of this embodiment is that, as shown in FIG. 6, by grasping with hands the second portion 2b of the main body 2 as the resiliently deformable actuating member, the pin detachment holes 17 of the pair of locking plates 16a, 16b change their state from a mutually separated state as shown in FIG. 7A to a mutually superposed position as shown in FIG. 7B, so that the pin 3 can be detached.

In other words, only by grasping with hands the second portion 2b of the main body 2 as the resiliently deformable actuating member, the locking member 16 is unlocked as shown in FIG. 6, and the user has only to pull out the main body 2 from the pin 3 by the grasping hands. Since the locking member 16 can be unlocked only by the action of grasping the main body 2, the action of the user is remarkably more rapid and surer in comparison with the case of requiring other actions for unlocking the locking member 16.

A strength of grasping the second portion 2b of the main body 2 as the resiliently deformable actuating member for unlocking the locking member 16 can be set at such a level that no improper operation occurs in consideration with women's or children's powers. With respect to the resiliently deformable portion, the level of the grasping strength can be easily set. Further, in the case of the resiliently deformable portion, on leaving the hand from the main body 2 after detaching the pin 3, the locking plates 16a, 16b return to the locking position. Therefore, even if the suspicious person or the like manages to mount the pin 3 to the main body again, he cannot mount the pin 3 in this state, which gives more time to a victim for running away.

Further, the string 8 to be passed around a belonging or a neck is attached to the pin 3 as the operation member and the pin 3 is held on the side of the belonging, therefore, when the main body 2 is pulled, it can be easily pulled away advantageously.

Further, a way of treating this portable alarm device 1 is that, when a suspicious person attacks a victim, the victim has only to detach the main body 2 from the pin 3 and throw the main body 2 emitting a loud alarm voice and sound away from the suspicious person. In this case, the suspicious person wavers in his determination as to whether he will come toward the victim or go toward the main body 2 thrown away and emitting a loud alarm voice and sound and hesitates for a moment, during which the victim has a chance of escape.

The sound emitted from the speaker 10c is preferably at full blast, since such a sound gives a psychological pressure to a suspicious person. In the case that the battery 8 comprises six button-type batteries, a sound at full blast can be maintained for about 15 minutes.

Further, the sound emitted from the speaker 10c may become gradually louder, and this is preferable because a strong psychological pressure can be also given to a suspicious person.

Further, since the time measurement data outputted from the time measuring section 15 on closing the switch 13 have been stored in the unvolatile memory 22, the following advantage can be obtained. That is, when the main body 2 is recovered after some time from an occurrence of an accident, the time of the occurrence of the accident can be precisely obtained on the basis of the data (time instant) read out from the unvolatile memory 22 of the main body 2. A terminal for reading out the data stored in the unvolatile memory 22 may be provided as an external interface.

Further, the abovementioned time measuring section 15 is for measuring the time instant, but it may be a time measuring section for measuring a lapse time after the switch 13 is closed. In such a case, when the main body 2 is recovered after some time from an occurrence of an accident, a lapse time after the occurrence of the accident can be obtained on the basis of an output from the time measuring section 15, and as a result, the time of the occurrence of the accident can be also precisely obtained. In this case, such an arrangement is allowable that a content stored in the unvolatile memory 22 is rewritten on the basis of an output from the time measuring section 15 and data relating to the lapse time are read out from the unvolatile memory 22. In this case, a terminal for reading out the data stored in the unvolatile memory 22 may be provided as an external interface.

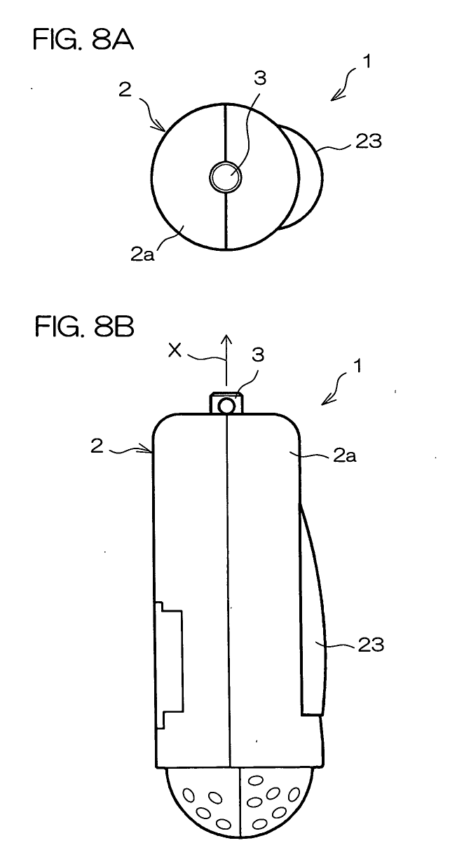

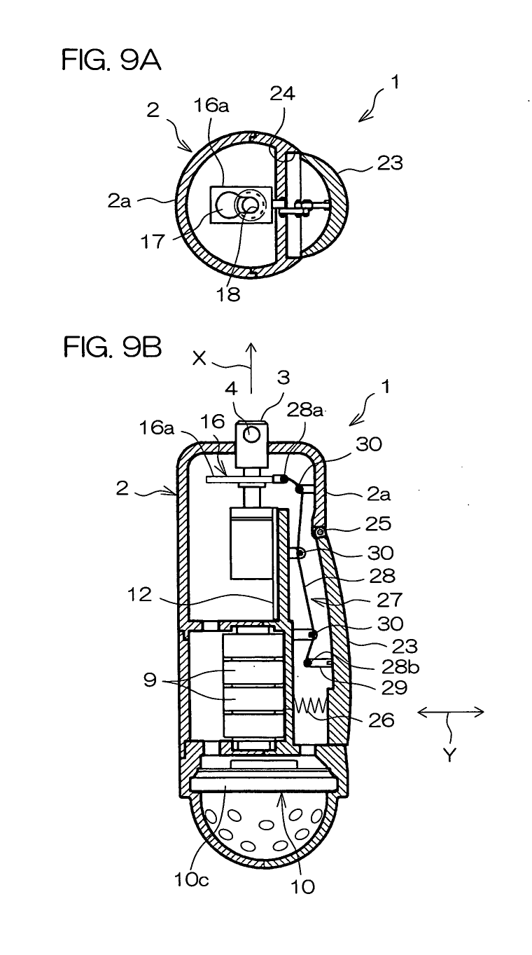

FIGS. 8 and 9 show another embodiment of the present invention. Referring to FIGS. 8 and 9, this embodiment is different from the embodiment of FIG. 1 mainly in the following points 1) to 3).

1) As shown in FIG. 9A, a second portion 23 of the main body 2 is a movable portion guided by a guide groove 24 formed in the first portion 2a of the main body 2 to move in the radial direction of the main body 2, and constitutes an actuating member (radially displacing member). In concrete, as shown in FIG. 9B, an upper end of the second portion 23 is pivotally supported by the first portion 2a through a pivot 25. However, since a movable range of the upper end portion of the second portion 23 is very small with respect to its rotation radius, the second portion 23 is displaced substantially in the radial direction of the main body 2. Further, a biasing member 26 comprising a compression coil spring biases the second portion 23 outwardly in the radial direction.

2) Only a single locking plate 16a is provided as a locking member. This locking plate 16a has the same structure as the locking plate 16a of FIG. 3 and has a pin detachment hole 17 and a pin detachment preventing channel 18.

3) A wire-type transmitting mechanism 27 is provided for transmitting an action of the second portion 23 as the actuating member to the locking member 16a. The wire-type transmitting mechanism 27 comprises a wire 28 one end 28a of which is secured to the locking plate 16a with the other end secured to a stay 29 fixed to the second portion 23, and a plurality of guide pins 30 for guiding the wire 28.

In this embodiment, similar effects to those of the embodiment of FIG. 1 can be obtained. In other words, when a user performs a series of actions of downwardly pulling the main body 2 with grasping the same in an emergency, the second portion 23 is inwardly pushed in the radial direction by the action of grasping the main body 2, and in accompany with this, the locking plate 16a is displaced through the wire-type transmitting mechanism 27, so that the lock is released. Therefore, the lock is easily and surely released.

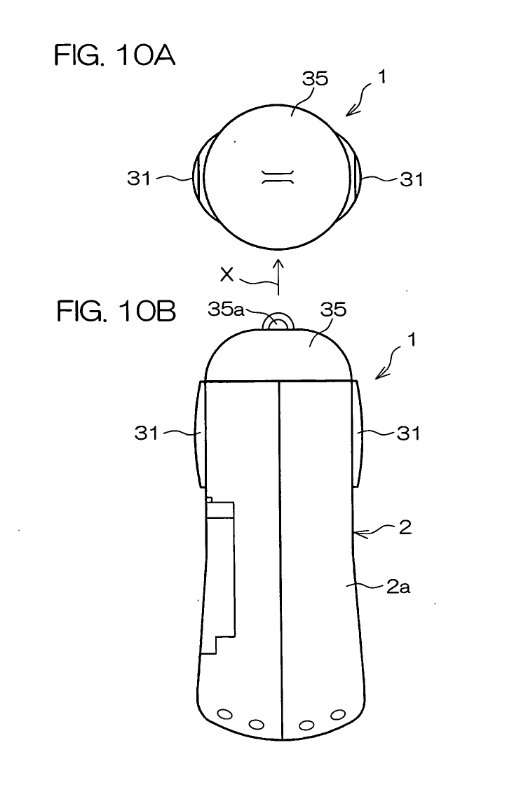

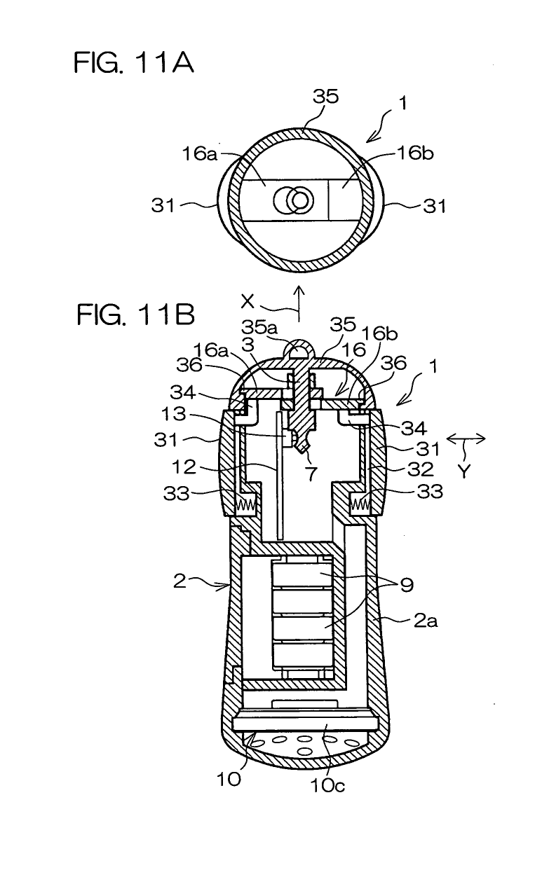

FIGS. 10 and 11 show a further another embodiment of the present invention. Referring to FIGS. 10 and 11, this embodiment is different from the embodiment of FIG. 1 mainly in the following points 1) to 4).

1) In the embodiment of FIG. 1, the second portion 2b of the main body 2 as the actuating member is a resiliently deformable member. However, in this embodiment, a pair of second portions 31 opposed in the radial direction of the main body 2 is movable portions displaceable in the radial direction of the main body 2 by guide of guide grooves 32 provided on the first portion 2a of the main body 2, and constitute the actuating member (radially displacing member). Each of the second portions 31 is biased outwardly in the radial direction by a corresponding biasing member 33 comprising a compression coil spring 33.

2) The pair of second portions 31 is respectively connected through connecting portions 34 to the corresponding locking plates 16a, 16b.

3) A dome-shaped cover 35 covering an upper portion of the main body 2 is provided integrally with the pin 3. This cover 35 is respectively engaged with outer end portions of the locking plates 16a, 16b so as to constitute labyrinth structures 36 respectively, thereby its tightness is improved. When the lock with respect to the pin 3 is released, the locking plates 16a, 16b are respectively displaced forwardly (inwardly in the radial direction of the main body 2) to release the engagement between the locking plates 16a, 16b and the cover 35. Therefore, the cover 35 does not prevent the detachment of the pin 3 from the main body 2.

4) An attachment hole 35a for attaching a string is provided in a top portion of the cover 35.

In this embodiment, similar effects to those of the embodiment of FIG. 1 can be obtained. In other words, when a user performs a series of actions of downwardly pulling the main body 2 with grasping the same in an emergency, both of the second portions 31 are inwardly pushed in the radial direction by the action of grasping the main body 2, and in accompany with this, both of the locking plates 16a, 16b are displaced, so that the lock is released. Therefore, the lock is easily and surely released.

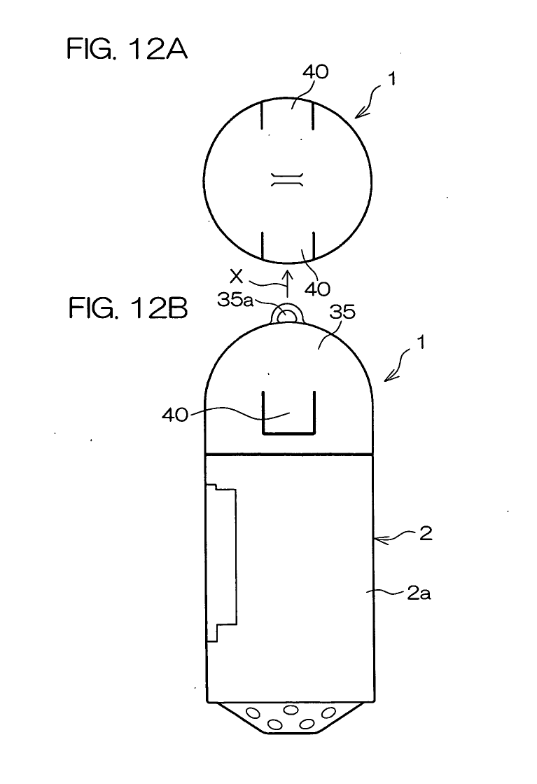

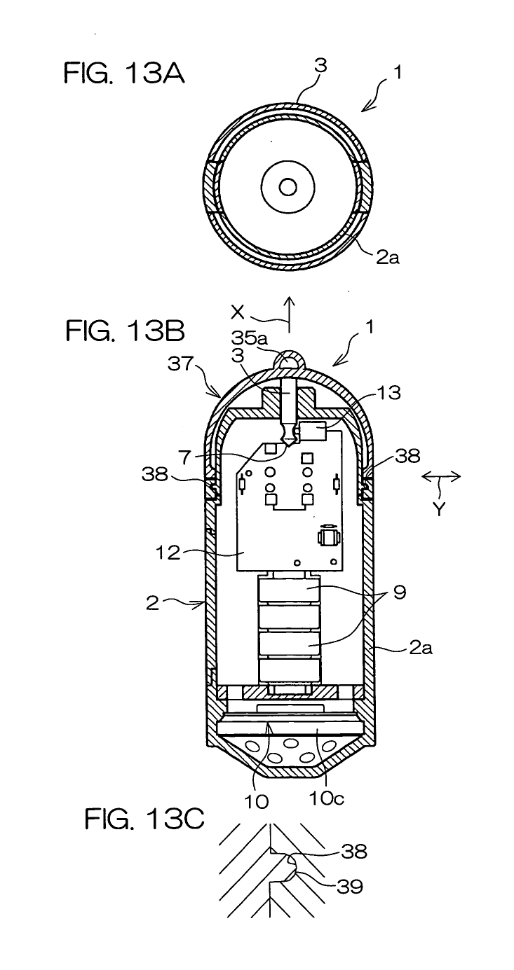

FIGS. 12 and 13 show a further embodiment of the present invention. Referring to FIGS., 12 and 13, this embodiment is different from the embodiment of FIG. 11 mainly in the following points 1) to 3).

1) In the embodiment of FIG. 11, the locking plates 16a, 16b to be engaged with the pin 3 are used, but in this embodiment, these locking plates are not used and a pair of locking portions 38 are provided which are radially opposed on an inner circumferential surface of an open end portion of a dome-shaped cover 37 as shown in FIG. 13B. As shown in FIG. 13C, the each locking portion 38 comprises a seizing groove, and this seizing groove seizes a locking projection 39 provided on a side portion of the main body 2, thereby preventing the cover 37 and the pin 3 integrally attached to the cover 37 from being detached from the main body 2. The locking portion 38 may be a locking projection to be seized by the seizing groove of the main body 2.

2) Further, as shown in FIG. 12, the cover 37 is provided with a pair of radially opposed press handling portions 40 as the actuating member (radially displacing member). The mutually opposed direction of the pair of press handling portions 40 and the mutually opposed direction of the abovementioned pair of locking portions 38 are perpendicular to each other. The pair of press handling portions 40 respectively comprises resilient tongue pieces defined by channel-shaped cut portions formed in the cover 37. The resilient tongue piece is elongated toward the open end side of the cover 37 in the manner of a cantilever.

3) The cover 37 comprises a resiliently deformable member. By pushing the pair of press handling portions 40 inwardly in the radial direction of the cover 37 (i.e. by reducing the distance between the pair of press handling portions 40), the distance between the pair of the locking portions 38 of the cover 37 becomes larger, so that the lock by each of the locking portions 38 is released.

Similar to the case of the embodiment of FIG. 11, an attachment hole 35a for attaching a string is provided in the top portion of the cover 37 in this embodiment. In this embodiment, similar effects to those of the embodiment of FIG. 11 can also be obtained.

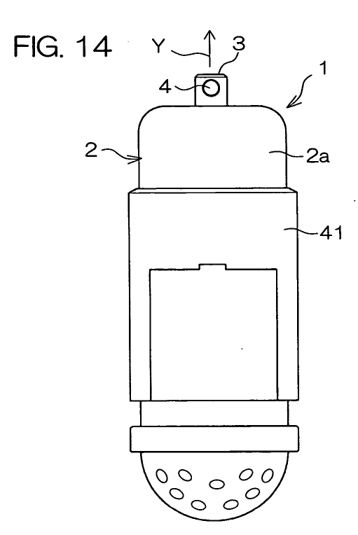

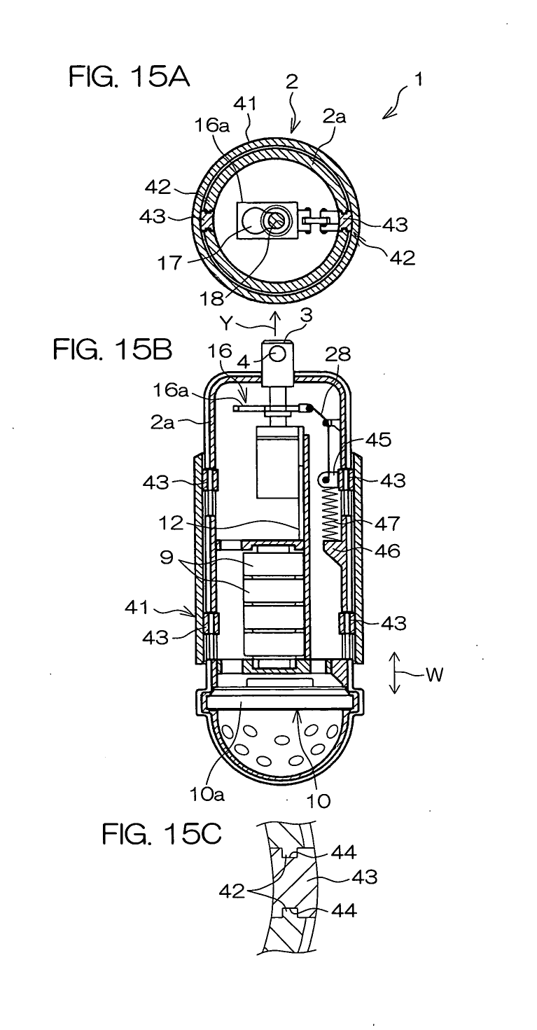

FIGS. 14 and 15 show a further another embodiment of the present invention. Referring to FIGS. 14 and 15, this embodiment is different from the embodiment of FIG. 9 mainly in the following points 1) to 3).

1) In the embodiment of FIG. 9, the second portion 23 as the actuating member is displaced in the radial direction Y of the main body 2, but in this embodiment, a second portion 41 as the actuating member (radial displacement member) comprises a cylindrical cover partly covering the outer circumferential surface of the first portion 2a of the main body 2, and this second portion 41 comprising the cylindrical cover is displaceable in the axial direction W of the main body 2.

2) As shown in FIG. 15A, the second portion 41 comprising the cylindrical cover is supported by guide structures 42 formed on the first portion 2a of the main body 2 so as to be displaceable in the axial direction W of the main body 2. In concrete, as shown in FIG. 15C, the guide structures 42 may be a guide ridge elongated in the axial direction W of the main body 2 and may be so adapted to be fitted into a groove 44 of a groove forming member 43 formed on the inner circumferential surface of the second portion 41. Otherwise, the guide structure 42 may be a guide groove elongated in the axial direction of the main body 2 and may be so adapted to be fitted with a ridge provided on the second portion 41.

3) A stay 45 is fixed to the groove forming member 43 of the second portion 41 comprising the cylindrical cover. And the stay 45 and the locking plate 16a are connected to each other through the wire 28 of the wire-type transmitting mechanism 27. Further, a biasing member 47 comprising a compression coil spring is interposed between a spring seat 46 formed on the first portion 2a of the main body 2 and the abovementioned stay 45. The biasing member 47 biases the second portion 41 through the stay 45 into a posture corresponding to the locked state (to the upper position in FIG. 15B).

According to this embodiment, when a user performs a series of actions of downwardly pulling the second portion 41b comprising the cover of the main body 2 with grasping the same in an emergency, the locking plate 16a is displaced through the wire 28 by the action of pulling the main body 2, so that the lock is released. Therefore, the lock is easily and surely released.

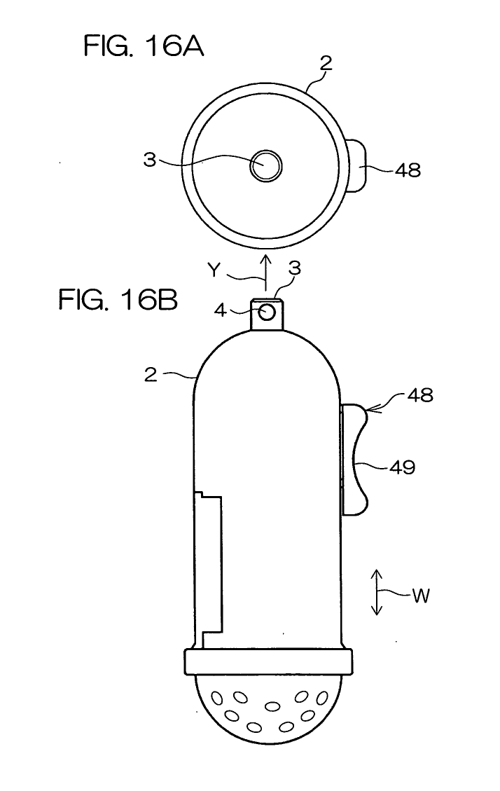

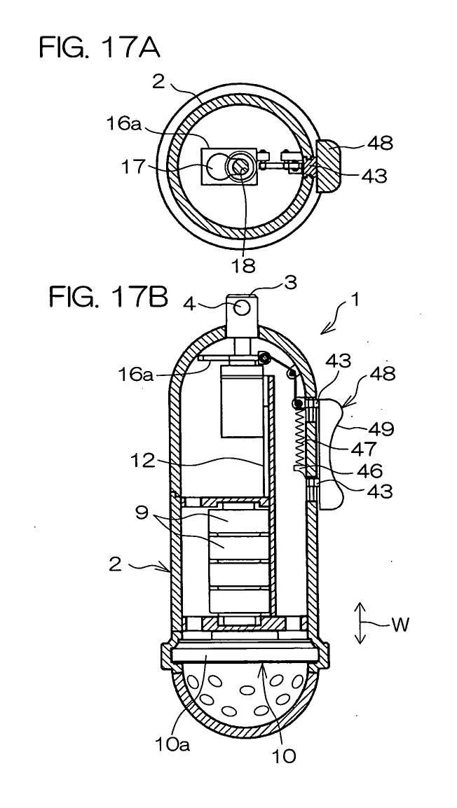

FIGS. 16 and 17 show a further another embodiment of the present invention. Referring to FIGS. 16 and 17, this embodiment is different from the embodiment of FIG. 15 mainly in the following points 1) to 3).

1) In the embodiment of FIG. 15, the second portion 41 comprising a cover constitutes the actuating member for releasing the lock. However, in this embodiment, instead of such an actuating member, an actuating member 48 (radially displacing member) which can be grasped together with the main body 2 is provided. The actuating member 48 comprises a vertically elongated long member formed to protrude from a part of the outer circumferential surface of the main body 2. A finger recess 49 is formed on an outer side surface of the actuating member 48. A finger recess 49 is provided so that when a user grasps the main body 2 together with this actuating member 48, the user's fingers easily engage with the recess 49.

2) The groove forming member 43 is fixed to the actuating member 48, and the groove forming member 43 and the locking plate 16a are connected to each other through the wire 28 of the wire-type transmitting mechanism 27.

3) Further, a biasing member 47 comprising a compression coil spring is interposed between a spring seat 46 formed on the first portion 2a of the main body 2 and the groove forming member 43.The biasing member 47 biases the actuating member 48 through the groove forming member 43 into a posture corresponding to the locked state (to the upper position in FIG. 17B).

According to this embodiment, when a user performs a series of actions of pulling the main body 2 together with the actuating member 48 downwardly (in the axial direction W) with grasping those in an emergency, the hand and the actuating member 48 slide along the main body 2 and the locking plate 16a is displaced through the wire 28, so that the lock is released. Therefore, the lock is easily and surely released.

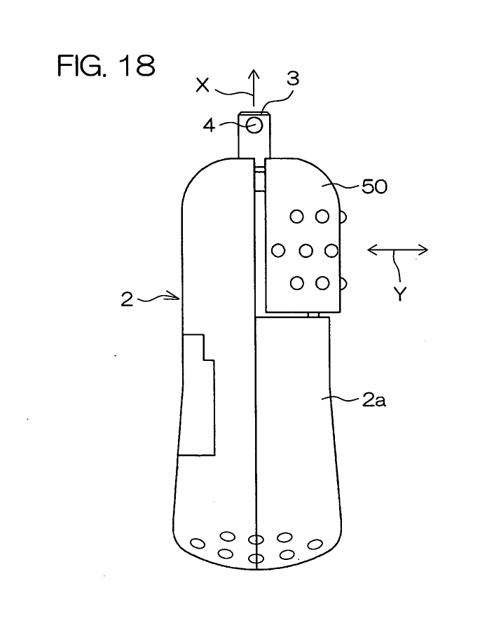

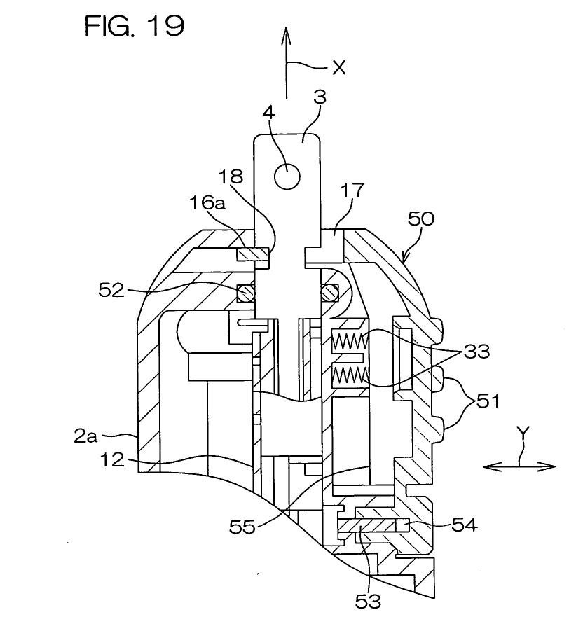

FIGS. 18 and 19 show a further another embodiment of the present invention. Referring to FIGS. 18 and 19, this embodiment is different from the embodiment of FIG. 11 mainly in the following points 1) to 4).

1) In the embodiment of FIG. 11, the pair of second portions 31 is provided as the actuating member displaceable in the radial direction of the main body 2. However, in this embodiment, only one second portion 50 is provided as the actuating member displaceable in the radial direction of the main body 2 (radially displacing member). The second portion 50 is provided on half the periphery of the main body 2. On an outer surface of the second portion 50, a plurality of projections 51 is distributed for preventing a user's hand from slipping when the user grasps the second portion 50 together with the first portion 2a of the main body 2.

2) In the embodiment of FIG. 11, the pair of locking plate 16a, 16b is used. However, in this embodiment, only one locking plate 16a is used, and this locking plate 16a and the second portion 50 are integrally formed of a single member.

3) In the embodiment of FIG. 11, the pin 13 is covered with the cover 35 formed integrally with the pin 3. However, in this embodiment, the pin 3 protrudes above the main body 2. AS shown in FIG. 19, on a circumferential surface of a longitudinal midway portion of the pin 3, an annular resilient member 52 such as an O-ring is fitted for providing friction to the pin 3 when a user releases the pin 3. The resilient member 52 is held by an annular groove formed on the first portion 2a of the main body 2.

4) As a guide structure for guiding the second portion 50 as the actuating member so as to be displaced in the radial direction Y of the main body 2, a guide projection 53 is provided on the first portion 2a of the main body 2. And the guide projection 53 is fitted into a groove 54 formed on the second portion 50. Further, a rib 55 is formed on a back surface of the second portion 50, and a pair of biasing members 33 protruding from the containing hole of the first portion 2a biases the second portion 50 outwardly in the radial direction Y through the rib 55.

In this embodiment, similar effects to those of the embodiment of FIG. 11 can be also obtained. Further, since the only one second portion 50 as the actuating member is provided, the structure of the device is simplified and the reliability of the operation becomes higher.

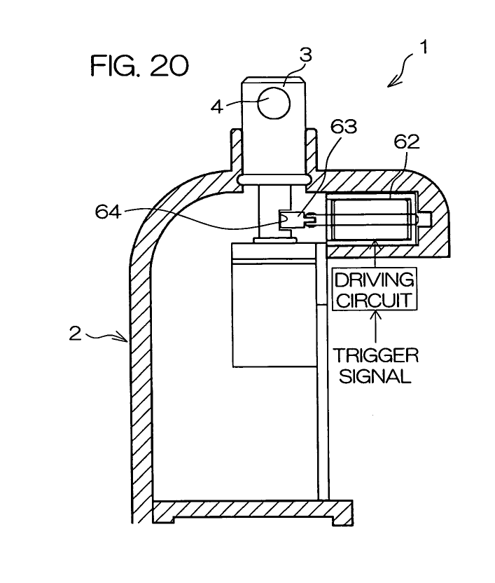

In the present invention, the structure for interlocking the actuating member and the locking member is not limited to such a structure of mechanical transmission using a wire-type transmitting mechanism as used in each of the embodiments of FIGS. 9, 15, and 17, but it may be one using an electric signal for interlocking. For example, as shown in the pattern view of FIG. 20, the lock may be released by applying a driving voltage from a driving circuit 61 to a solenoid 62 on the basis of a trigger signal obtained by displacement of the actuating member in the radial or axial direction of the main body and thereby releasing a locking member 63 connected to the solenoid 62 from an engaging groove 64. Further, in each of the embodiments of FIGS. 9, 15 and 17, a biasing member for directly biasing the locking plate 16a to the locked position may be provided.

The present invention has been described by way of the concrete embodiments as above, and those skilled in the art who have understood the abovementioned description will be easily able to think of the variations, modifications and equivalents thereof. Therefore, the present invention should be limited by the scope of appended claims and their equivalents.

What is claimed is:

1. A portable alarm device comprising
a cylindrical main body containing an alarm sound emitting unit and a switch for operating the alarm sound emitting unit,
an operation member which allows the switch to close when the operation member is being detached from the main body in an axial direction of the main body,
a locking member provided in the main body and displaceable between a locking position for preventing the detachment of the operation member and a unlocking position for allowing the detachment of the operation member, and
an actuating member for actuating the locking member to the unlocking position in accompany with either an action of grasping the main body in a radial direction of the main body by hand or an action of relative movement of the operation member and the main body grasped by hand in the radial direction of the main body.

2. A portable alarm device according to claim 1, in which
the actuating member comprises either a radially displacing member or an axially displacing member.

3. A portable alarm device according to claim 2, in which
the radially displacing member is displaced in the radial direction of the main body in accompany with an action of grasping the main body together with the actuating member in the radial direction of the main body, so that the locking member is actuated to the unlocking position by the radially displacing member.

4. A portable alarm device according to claim 2, in which
the axially displacing member is displaced in the axial direction of the main body in accompany with an action of detaching the operation member and the main body from each other, so that the actuating member is actuated to the unlocking position by the axially displacing member.

5. A portable-alarm device according to claim 1, in which
the operation member comprises a pin directly or indirectly attached with a string, belt or chain to be passed around a belonging or a neck.

6. A portable alarm device according to claim 5, in which
the pin includes an engaging portion, and the locking member includes a seizing portion engageable with the engaging portion of the pin to prevent the detachment of the pin.

7. A portable alarm device according to claim 6, in which
the pin comprises a pin having relatively wide portion and a relatively narrow portion.

8. A portable alarm device according to claim 7, in which
the locking member comprises at least one locking plate supported by the main body so as to be displaceable in a direction perpendicular to the detachment direction of the pin, and
the locking plate is provided with a pin detachment hole through which the relatively wide portion of the pin can penetrate, and a pin detachment preventing channel extended from the pin detachment hole and through which the relatively wide portion of the pin cannot penetrate but the relatively narrow portion of the pin can penetrate.

9. A portable alarm device according to claim 8, in which
the locking member comprises a pair of locking plates, and
the detachment of the pin is prevented by superposing the pin detachment holes of the pair of locking plates with each other.

10. A portable alarm device according to claim 1, further comprising
a biasing member for biasing the locking member toward the locking position.

11. A portable alarm device according to claim 1, further comprising
a transmitting mechanism for transmitting an action of the actuating member to the locking member.

12. A portable alarm device according to claim 11, in which
the transmitting mechanism includes a wire.

13. A portable alarm device according to claim 11, in which
the transmitting mechanism includes a solenoid which operates on the basis of a predetermined signal.

14. A portable alarm device according to claim 1, further comprising
a time measuring unit contained in the main body which measures a lapse time from a base time and outputs the same as a time measurement data, and
an unvolatile memory for storing the time measurement data outputted from the time measuring unit in accompany with the closing of the switch.

15. A portable alarm device according to claim 1, further comprising
a time measuring unit for measuring a lapse time from the time when the switch is closed.

16. A portable alarm device according to claim 1, in which
in an emergency the main body grasped by hand is detached from the operation member, so that the main body can be thrown away.
